(19) United States
(12) Patent Application Publication
(10) Pub. No.: US 2014/0354174 A1
(43) Pub. Date: Dec. 4, 2014

(54) INFRARED EMITTING DIODE DRIVING CIRCUIT AND REMOTE CONTROL

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: HAI-DONG TANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/951,406

(22) Filed: Jul. 25, 2013

(30) Foreign Application Priority Data
May 30, 2013 (CN) 2013102099676

(51) Int. Cl. H05B 33/08

(52) U.S. Cl. CPC H05B 33/0812
USPC 315/291

(57) ABSTRACT

An infrared emitting diode driving circuit includes a first resistor includes a first terminal and a second terminal, a second resistor, and a transistor with the emitter grounded via the second resistor. The circuit further includes an infrared emitting diode with the anode connected to a power source and the cathode connected to the collector of the transistor. A control chip of the circuit turns the transistor on and off. The control chip is connected to a first terminal of the first resistor. The circuit further includes a voltage clamping unit to clamp voltage at the base of the transistor to a fixed value. One end of the voltage clamping unit is connected to the second terminal of the first resistor and the base of the transistor, and another end of the voltage clamping unit is grounded.

### BACKGROUND

1. Technical Field

The present disclosure relates to remote controls, and particularly to an infrared emitting diode driving circuit and a remote control using the infrared emitting diode driving circuit.

2. Description of Related Art

FIG. 2 shows a known infrared emitting diode driving circuit 100 of a remote control. The driving circuit 100 includes a power source Vbat, resistors R1, R2, an infrared emitting diode 10, a transistor 12, and a control chip 14 to turn the transistor 12 on and off. The anode of the infrared emitting diode 10 is connected to the power source Vbat via the resistor R1, and the cathode of the infrared emitting diode 10 is connected to the collector of the transistor 12. The control chip 14 is connected to the transistor 12 via the resistor R2. The emitter of the transistor 12 is grounded. The forward current flowing through the infrared emitting diode 10 is determined by the power source Vbat. When the voltage of the power source Vbat decreases, the value of the forward current correspondingly decreases. Thus, the intensity of the infrared signal emitted by the infrared emitting diode 10 correspondingly decreases. That is, the intensity of the infrared signal emitted by the infrared emitting diode 10 will vary with any variations in voltage, which may affect the performance of the remote control.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a circuit diagram of an infrared emitting diode, in accordance with an exemplary embodiment.

FIG. 2 is a circuit diagram of a known infrared emitting diode.

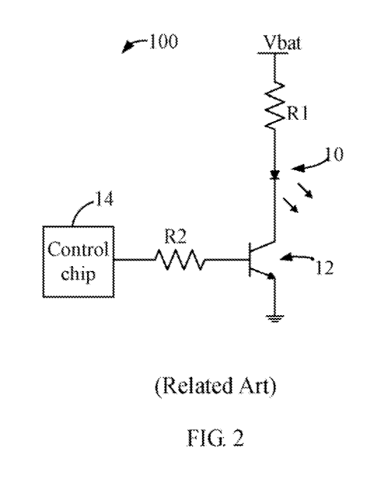

### DETAILED DESCRIPTION

Embodiments of the present disclosure are described, with reference to the accompanying drawings.

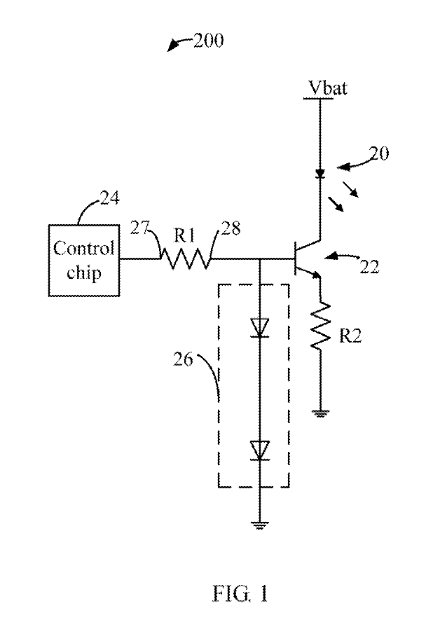

FIG. 1 shows an embodiment of an infrared emitting diode driving circuit 200. The driving circuit 200 includes a power source Vbat, an infrared emitting diode 20, a transistor 22, resistors R1, R2, a control circuit 24, and a voltage clamping unit 26. The anode of the infrared emitting diode 20 is connected to the power source Vbat, the cathode of the infrared emitting diode 20 is connected to the collector of the transistor 22. The emitter of the transistor 22 is grounded via the resistor R2. The resistor R1 includes a first terminal 27 and a second terminal 28. The control chip 24 is connected to the first terminal 27 of the resistor R1. The control chip 24 turns the transistor 22 on and off. An end of the voltage clamping unit 26 is connected to the second terminal 28 of the resistor R1 and the base of the transistor 22, and another end of the voltage clamping unit 26 is grounded. In this embodiment, the voltage clamping unit 26 includes two switching diodes. A forward voltage drop of the switching diode is 0.6V, thus the clamping voltage of the voltage clamping unit 26 is 1.2V, and the voltage at the base of the transistor 22 is clamped to 1.2V. When the voltage at the base of the transistor 22 is clamped to 1.2V, the voltage at the emitter of the transistor 22 is clamped to 0.6V. In an alternative embodiment, the voltage clamping unit 26 includes two voltage stabilizing diodes connected back-to-back.

In this embodiment, the voltage at the base of the transistor 22 is fixed, the voltage at the emitter of the transistor 22 is fixed, thus the emitter current Ie of the transistor 22 is fixed, and the collector current Ic is fixed. Therefore, in this embodiment, if the voltage of the power source Vbat varies, the current flowing through the infrared emitting diode 20 remains unchanged, thus the intensity of the signal emitted by the infrared emitting diode 20 remains unchanged.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An infrared emitting diode driving circuit comprising:
a first resistor comprising a first terminal and a second terminal;
a second resistor;
a transistor with the emitter grounded via the second resistor;
an infrared emitting diode with the anode connected to a power source and the cathode connected to the collector of the transistor;
a control chip to turn the transistor on and off, wherein the control chip is connected to a first terminal of the first resistor; and
a voltage clamping unit to clamp voltage at the base of the transistor to a fixed value, wherein, one end of the voltage clamping unit is connected to the second terminal of the first resistor and the base of the transistor, and another end of the voltage clamping unit is grounded.

2. The driving circuit as described in claim 1, wherein the voltage clamping unit comprises two switching diodes connected in-series.

3. The driving circuit as described in claim 1, wherein the voltage clamping unit comprises two voltage stabilizing diodes connected back-to-back.

4. The driving circuit as described in claim 1, wherein the fixed value is 1.2V.

5. The driving circuit as described in claim 4, wherein the voltage at the emitter of the transistor is fixed to 0.6V.

6. A remoter controller comprising:
an infrared emitting diode driving circuit comprising:
a first resistor comprising a first terminal and a second terminal;
a second resistor;
a transistor with the emitter grounded via the second resistor;
an infrared emitting diode with the anode connected to a power source and the cathode connected to the collector of the transistor;
a control chip to turn the transistor on and off, wherein the control chip is connected to a first terminal of the first resistor; and
a voltage clamping unit to clamp voltage at the base of the transistor to a fixed value, wherein, one end of the voltage clamping unit is connected to the second terminal of the first resistor and the base of the transistor, and another end of the voltage clamping unit is grounded.

7. The remote control as described in claim 6, wherein the voltage clamping unit comprises two switching diodes connected in-series.

8. The remote control as described in claim 6, wherein the voltage clamping unit comprises two voltage stabilizing diodes connected back-to-back.

9. The remote control as described in claim 6, wherein the fixed value is 1.2V.

10. The remote control as described in claim 9, wherein the voltage at the emitter of the transistor is fixed to 0.6V.
